(19) United States
(12) Patent Application Publication
(10) Pub. No.: US 2008/0022581 A1
(43) Pub. Date: Jan. 31, 2008

(54) SNAG RESISTANT LINE REVERSING DEVICE FOR FISHING TACKLE

(75) Inventor: Donald J. Link, Shakopee, MN (US)

Correspondence Address: ALTERA LAW GROUP, LLC, 6500 CITY WEST PARKWAY, SUITE 100, MINNEAPOLIS, MN, 55344-7704, US

(73) Assignee: Skirts Plus Corporation

(21) Appl. No.: 11/866,322

(22) Filed: Oct. 2, 2007

Related U.S. Application Data
(63) Continuation of application No. 11/316,507, filed on Dec. 22, 2005, now abandoned.
(60) Provisional application No. 60/639,433, filed on Dec. 27, 2004.

(51) Int. Cl. A01K 95/00

(52) U.S. Cl. 43/44.97

(57) ABSTRACT

This disclosure is directed to a fishing system capable of reducing loss due to entanglement with environmental obstacles. The most common form of device is a sinker. The construction of this system allows the user tension the line in different direction to extricate the fishing element from obstacles by easily reversing the direction of line tension.

### CROSS-REFERENCE TO RELATED APPLICATIONS

This application claims priority to U.S. Provisional Patent Application Ser. No. 60/639,433, filed Dec. 27, 2004.

### STATEMENT REGARDING FEDERALLY SPONSORED RESEARCH OR DEVELOPMENT

Not Applicable.

### FIELD OF THE INVENTION

The present invention is directed to a fishing device most commonly a sinker, and more particularly to a fishing sinker with improved resistance to snags and capable or reversing line direction to be withdrawn from obstacles.

### BACKGROUND OF THE INVENTION

When fishing, one generally wants the fishing line and attached bait or lure to sink below the water surface, so that the bait may be seen by the fish. Typically, one attaches a sinker to a fishing line, which is generally a weight with a density greater than water. The sinker may be attached to the fishing line at a fixed position, or may be able to slip or slide along a portion of the line. These slidable sinkers are generally referred to as slip sinkers. The sinker may be made of a dense metal, such as lead or an alloy of lead, and may have a protective coating to prevent significant contact between the lead and the water. The sinker may also have a buoyant portion in addition to the dense portion, in order to achieve a desired orientation in the water. The sinker may optionally be colored in a manner that is appealing to fish, such as a combination of bright, fluorescent colors.

Fishing sinkers tend to sink to the bottom of the fishing area, and a common drawback is that they may become snagged in fishing areas with rocks, brush, weed beds or stump fields (i.e. become engaged with environmental obstacles). When a sinker becomes snagged, one typically attempts to free the sinker by pulling generally upward on the fishing pole. If that doesn't work, one may let the line go slack, translate the pole a few feet in a given direction parallel to the water surface, then attempt to pull upward again. The process of letting the line go slack, translating the pole and pulling upwards may be repeated until the sinker is freed, or until patience is lost and the sinker is abandoned.

Abandoning a sinker is undesirable for a number of reasons. First, the sinker costs money to replace. Second, the sinker may contain lead and may potentially contaminate the fishing area. Third, the individual who lost the sinker may be subject to hurtful ridicule from his or her fishing companions.

Accordingly, there exists a need for a sinker with improved snag resistance, so that the process of letting the line go slack, translating the pole and pulling upwards may be more effective at freeing a snagged sinker.

### SUMMARY

There are several aspects to the invention and reference should be had to the detailed description and the claims. For the reader's convenience a summary of some of salient features appears below.

For example, one embodiment includes a snag resistant fishing sinker system which has a first filament having a first and second end, a sinker weight being attached to said first filament proximate said ends, an attachment link to a fishing line, slidably engaging said first filament so that it can selectively slide between ends; so that the link can be moved by tensioning of a fishing line to avoid entanglement of the system with environmental obstacles.

A further feature includes a system where the first filament is substantially rigid.

In another embodiment, the system of claim 2 wherein said first and second ends are attached to said sinker weight to form at least one corner.

In another embodiment the first and second ends are attached to the sinker weight to form at least two corners and wherein the link is slidable between said corners.

In another embodiment the first filament includes a bend intermediate said first and second ends so that said link may engage said either said first or second end or said bend.

In a further embodiment, the bend is generally midway between said first and second ends and forms an apex between said ends.

In a further embodiment, the said bend is generally midway between said first and second ends and wherein said filament follows a generally arcuate shape.

In a further embodiment the arcuate shape is concave relative to the sinker weight.

In a further embodiment the filament extends generally from said first to said second end and a float slidable therealong.

In a further embodiment the float has sufficient buoyancy to tend to raise whichever end it is most adjacent.

In a further embodiment the further filament is substantially rigid.

In a further embodiment the filament is substantially rigid and extends from the sinker weigh at one end thereof, follows around the sinker weight toward its other end and terminates at the sinker weight adjacent the first end and has a corner adjacent its second end, so that the link may be moved from the first end to the second to avoid environmental entanglement.

A method of making a snag resistant sinker system is also disclosed including the steps of suspending a fishing element to the ends of a substantially rigid filament; establishing a plurality of corner bends in said filament; slidably attaching a fishing line to said filament capable of sliding therealong and engaging said bends; so that tensioning the fishing line at different angles can cause the slidable attachment to move to bend most effective in disentangling said sinker system from environmental obstacles.

The above summary is just exemplary. Reference should be had to the detailed description for further inventive concepts and to the claims.

### BRIEF DESCRIPTION OF THE SEVERAL VIEWS OF THE DRAWINGS

FIG. 1 illustrates a prior art fishing sinker.

FIG. 2 illustrates a prior art fishing sinker, wedged between two rocks.

FIG. 3 illustrates an embodiment of a fishing sinker.

FIG. 4 illustrates an embodiment of a fishing sinker, wedged between two rocks.

FIG. 5 illustrates an embodiment of a fishing sinker, wedged between two rocks.

FIG. 6 illustrates a further embodiment of a fishing sinker, with a filament with rounded corners.

FIG. 7 illustrates a further embodiment of a fishing sinker, with a filament with more than two corners.

FIG. 8 illustrates a further embodiment of a fishing sinker, with a weight that is slidable along the filament.

FIG. 9 illustrates a further embodiment of a fishing sinker, with a rattle.

FIG. 10 illustrates a further embodiment of a fishing sinker, with a float incorporated into the clasp.

FIG. 11 illustrates a further embodiment of a fishing sinker, with a float that is slidable along a filament.

FIG. 12 illustrates a further embodiment of a fishing sinker, with a gumdrop-shaped weight.

FIG. 13 illustrates a further embodiment of a fishing sinker, with a gumdrop-shaped weight and a rattle.

FIG. 14 illustrates a further embodiment of a fishing sinker, with a weight on a slidable clasp.

FIG. 15 illustrates a further embodiment of a fishing sinker, with a more than one slidable clasp.

FIG. 16 illustrates a further embodiment of a fishing sinker, with a decorated weight, multiple hooks, and a hydrodynamic fin.

### DETAILED DESCRIPTION OF THE INVENTION

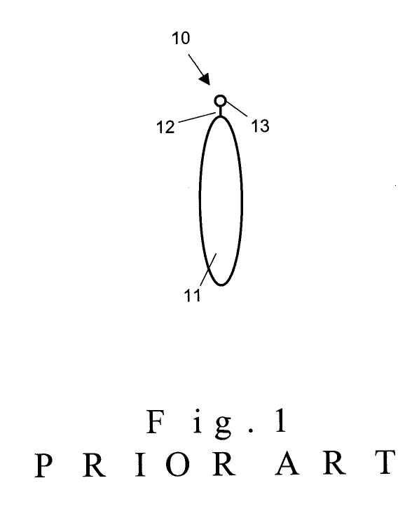

A prior art fishing sinker 10 is shown in FIG. 1. A weight 11 is rigidly attached to a clasp/link 13 by a filament 12. The clasp 13 may either attach directly to a fishing line, between the bait and the pole, or may attach to an intermediate device that enables attachment to the fishing line. The term clasp or attachable link should be read broadly as the connection to the fishing line, and indeed the fishing line itself. In can be as simple as a slidable knot or complex as a link element which itself attaches to the fishing line. Once cast into a fishing area, the prior art sinker 10 sinks and carries the bait below the surface of the water to a depth at which it may be seen by the fish.

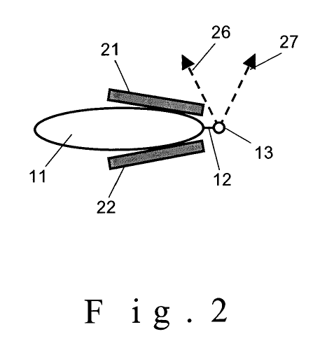

As the fisherman artfully adjusts the positions of the pole/rod and the line, in order to entice fish to eat the bait, the prior art sinker 10 may become entangled in some structures on the bottom of the fishing area. For instance, it may become wedged between rocks, or snagged in plant beds. FIG. 2 shows the prior art sinker wedged between two rocks 21 and 22. (The rocks 21 and 22 are drawn with a rectangular profile for simplicity.) In an attempt to free the snagged sinker, the fisherman may use the pole to exert a force on the line, and in turn, exert a pulling force on the sinker. This pulling force is represented schematically by element 27, and shows the direction in which the fisherman pulls. The pulling force denoted by 27 is exerted on the clasp 13, and based on the orientation of the wedge of the rocks 21 and 22, FIG. 2 shows that such a force will not free the snagged sinker.

Once the fisherman realizes that pulling in the direction denoted by 27 will not free the snagged sinker, he may optionally shift his position in the boat or on the dock, then try pulling in a second direction. This second direction is denoted by element 26, and a pulling force denoted by direction 26 is also exerted on the clasp 13. FIG. 2 shows that this force, too, will not free the snagged sinker. Presumably, the fisherman will be unable to dislodge the prior art sinker using the fishing line, and will have to abandon the prior art sinker at the bottom of the fishing area, possibly leaving lead at the bottom of the lake.

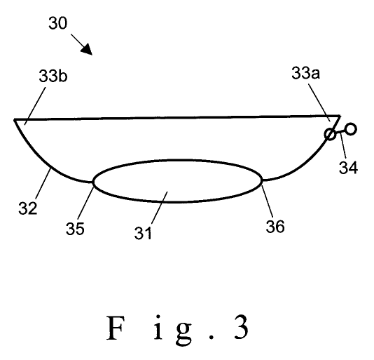

FIG. 3 shows an embodiment of a fishing sinker 30 with improved snag resistance. A sinker has been illustrated throughout, but it is understood that any fishing element could be used in this configuration. A lure, a spinner, rattle, bait (live or synthetic) or any fishing device that can be tied to a fishing line, is liable to become entangled in environmental obstacles. Because sinker weights are the most problematic, they are used for illustration, but should not be considered a limitation of the invention. A weight 31 may be formed generally from a dense material, such as lead or an alloy of lead, and may have a protective coating to prevent significant contact between the lead and the water. The weight 31 may also have a buoyant portion (not shown), in order to achieve a desired orientation in the water. The weight 31 may optionally be colored in a manner that is appealing to fish, such as one or more bright, fluorescent colors. Furthermore, the weight 31 may preferably have an elongated or tubular shape, with a first end 35 and a second end 36. The weight 31 is preferably located at the midpoint between the corners (end points) but as it is not on the same filament, spaced therefrom. Thus the center of gravity of the weight (or other fishing device) will preferably along a line running orthogonally through the midpoint between the corners. (This is only true on non slidable embodiments, of course)

The first end 35 and second end 36 may be connected by a filament 32 having a linear/straight section and arcuate sections. The filament 32 may preferably be a generally or substantially rigid wire, which may optionally be coated to prevent corrosion. Its rigidity should be taken broadly. It should be rigid enough that the link can slide therealong. It can also be very rigid as that would aid in slidability. Alternatively, the filament 32 may be made from a synthetic material, such as plastic or nylon. The filament 32 may extend externally from the first end 35 to the second end 36, and may be joined to the weight 31 only at the ends 35 and 36. Alternatively, the filament 32 may extend partially into the weight 31, or may pass completely through a hole (not shown) in the weight 31. In the embodiment of FIG. 3, it is preferable that the weight 31 be rigidly attached to the filament 32. In further embodiments, the weight may slide along the filament, which extends through a hole in the weight.

A clasp 34 is slidably attached to the filament 32. In this case, a sliding ring is shown, but any means for slidable engagement is possible so long as the resistance is low. The clasp 34 may either attach directly to a fishing line, between the bait and the pole, or may attach to an intermediate device that enables attachment to the fishing line.

The filament 32 preferably has one or more corners 33a, 33b. (Note that “corners” (interchangeably used with “bends”, “junctions”, etc., should be interpreted broadly and junctions or bends and are not limited to corners in the traditional sense.) The link 34 is slidably engaged along the filament and may engage any of the corners/bends so as to allow the fishing line to alter the vector or directional force applied to the sinker system thereby resulting in reversal or partial change of direction depending upon where the bends are located along the filament.) Although the corners 33a, 33b are drawn as sharp corners, they may be formed as regions in which the local curvature is distinctly greater than the surrounding regions. Sharper or acute angle corners may have an advantage that the reversing function is stepwise and more distinct, as will be explained below. In other words, the corners 33a, 33b may be simply bends in the filament 32, with a local radius of curvature that is conducive to well-known wire manipulation techniques. If the filament 32 is formed from a synthetic material, rather than shaped from a wire, then the corners 33a, 33b may either be sharp, or may be rounded.

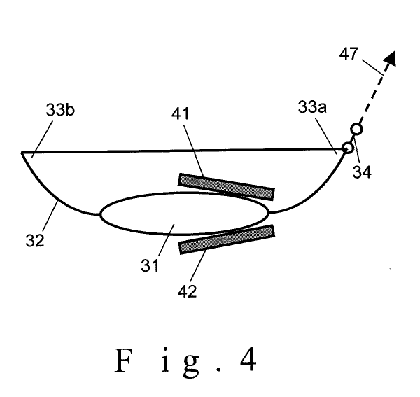

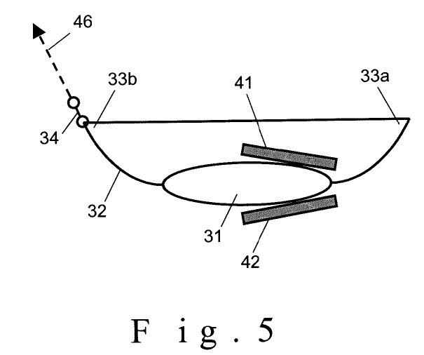

A utility of the two corners 33a, 33b is visible from FIGS. 4 and 5, in which the sinker 30 is shown wedged between two rocks 41 and 42. (As in FIG. 2, the rocks are drawn as rectangular in profile for simplicity. Furthermore, it should be noted that the rocks may be rotated by 90 degrees about the longitudinal axis of the weight 31, so that one rock is below the plane of the page, and one rock is above the plane of the page. This orientation as described is more likely in practice, but more difficult to draw in a single-pane representation.)

Analogous to FIG. 2, the fisherman first pulls along a direction denoted by element 47 in FIG. 4, and is unable to free the snagged sinker. However, as shown in FIG. 5, when the fisherman shifts the direction of pull, denoted by element 46, the clasp 34 first slides from corner 33a to corner 33b, then applies a force at corner 33b in the direction of 46. Unlike force 47, the force denoted by 46 is applied against the direction of the wedge of rocks (weeds, branches, etc.) 41 and 42, and may therefore extract the snagged sinker from the rocks 41 and 42. Therefore, compared with the prior art sinker 10, the sinker 30 shows an improved snag resistance.

One potential contributor to the improved snag resistance of sinker 30 may be the allowed reversibility of the sinker's motion. Unlike the prior art sinker 10, the sinker 30 allows the clasp position to change, depending on the direction of pull. In the embodiment of FIGS. 3-5, the two corners 33a and 33b are on opposite sides of the weight 31, and when the clasp 34 engages each of these corners, the sinker 30 may be pulled in opposite directions. If a particular motion (caused by force 47) manages to wedge the sinker 30 between two rocks, as in FIG. 4, then a corresponding motion (caused by force 46) in another direction should therefore be able to dislodge the sinker. The ability to retract the sinker, or extract a sinker from a snagged location, may be known as reversibility.

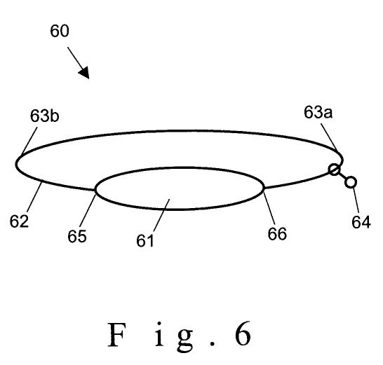

FIG. 6 shows an additional embodiment of a sinker 60. A preferably elongated weight 61 has its first end 65 connected to its second end 66 by a filament 62. A clasp 64 is slidably engaged along the filament at one end, and at its second end, either attaches directly to a fishing line between the bait and the pole or, alternatively, attaches to an intermediate device that enables attachment to the fishing line. The filament has two corners 63a and 63b that may engage the clasp 64 when forces are applied in the appropriate directions. Note that the corners 63a and 63b may be either rounded or sharp, preferably acute, such as between 30 and 45 degrees. Here again, the term corners must be read broadly as they are clearly just angular bends. The concept of filaments “joined” at corners is applicable also, but the meaning of joined, must also include a continuous filament and the joining is not physically distinguishable.

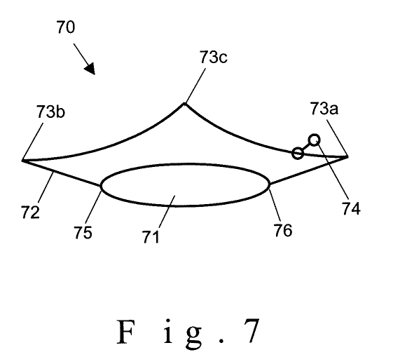

FIG. 7 shows an additional embodiment of a sinker 70. Drawing elements 70-76 are analogous to 60-66 and 30-36. In comparison with sinker 60 in FIG. 6, note that the filament 72 may have more than two corners. In particular, filament 72 has three corners 73a, 73b and 73c to form a “crown of these points, with corner 73c at the apex. Note that the sections of filament 72 between corners may be either straight or curved. Those portions of the filament between 73a-b-c are also straight or curved. If curved, they are preferably an arcuate shape, convex as viewed from the sinker weight 71. This convex interior helps keep the link/claps 74 in one of the bends/corners in response to tension of the fishing line pulled along a selected vector. In particular, filament 72 is curved inwards between corners 73a, 73b and 73c. An inward curve may be preferable, in that it may guide the slidable clasp 74 more readily to a corner 73a, 73b or 73c. Note that the corners 73a, 73b and 73c may all be sharp, as drawn, or may preferably be slightly rounded in order to simplify the manufacturing process. The advantage of this structure is that the apex point provides an alternative “exit” direction of pull in case the other directions are not sufficient to extricate the sinker. Likewise, additional corners or bending points will provide additional angles for extrication.

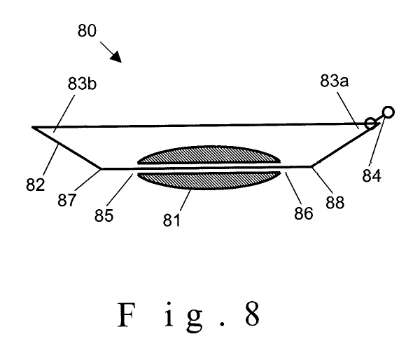

FIG. 8 shows an additional embodiment of a sinker 80. A weight 81 with a first end 85 and a second end 86 is hollowed out (i.e. being in slidable engagement with the filament, and having a passage of greater diameter that the filament outer diameter), and is drawn in cross-section in FIG. 8. A filament 82 passes through the hole in the weight 81, and the weight 81 may slide along a section of the filament 82 between corners 87 and 88. A clasp 84 is slidably attached to the filament 82, which may slide between corners 83a and 83b depending on the direction of pull, as shown in FIGS. 4 and 5. Note that the corners 87 and 88 may preferably not engage the slidable clasp 84; the directions of pull as shown in FIGS. 4 and 5 preferably guide the slidable clasp 84 to either corner 83a or 83b. Any or all of the corners 83a, 83b, 87 and 88 may optionally be rounded, as well as the sections of filament between them.

Using a sliding weight, such as element 81 in FIG. 8, may be advantageous in achieving a desired orientation for the sinker. For instance, if the sinker 80 is suspended by the clasp 84 and engaged at corner 83a, then weight 81 slides along the filament 82 until it reaches corner 85, thereby shifting the center of mass away from 83a, and increasing the rotational inertia of the sinker 80. (Rotational inertia may sometimes be referred to as moment of inertia.) Because the rotational inertia (about the clasp) is increased, it takes a greater force to change the orientation of the sinker. Put another way, given a particular set of obstacles at the bottom of a fishing area, a sinker may be more likely to stay in its desired orientation if its rotational inertia is increased.

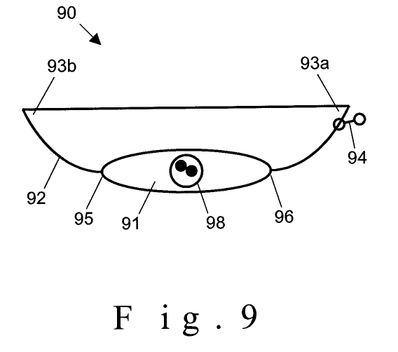

FIG. 9 shows an additional embodiment of a sinker 90. Drawing elements 90-96 are analogous to 30-36, except that the weight 91 includes a rattle 98. The use of rattles is generally well-known to fisherman, and the thumps, ticks, clicks and clatters that rattles emit are known to lure fish. The rattle 98 may be a generally hollow cavity, in which several ball bearings may roll around and knock into each other. Although FIG. 9 shows the rattle 98 surrounded by the weight 91, the rattle 98 may also be embedded on an edge of the weight 91, or attached externally to the weight 91. Furthermore, the rattle 98 may be detached from the weight 91, and either free to slide along the filament 92 independent of the weight 91, or fixedly attached to the filament 92 or the clasp 94.

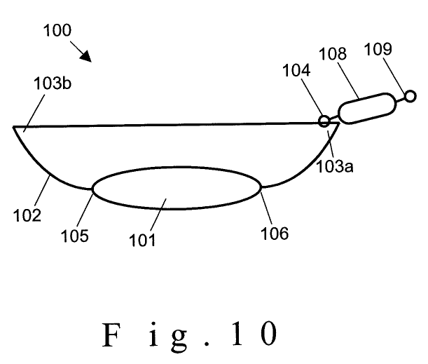

FIG. 10 shows an additional embodiment of a sinker 100. Drawing elements 100-106 are analogous to 30-36, except that the slidable clasp 104 includes a float 108, which attaches to the fishing line by an additional clasp 109. The additional clasp 109 may either attach directly to the fishing line, between the bait and the pole, or may attach to an intermediate device that enables attachment to the fishing line. The float 108 may be made of a buoyant material with a density less than water, such as cork or balsa. Alternately, the float 108 may contain a pocket of low-density material, such as an air bubble, preferably sealed to minimize contact with the water. The float helps orient the fishing line vertically and may keep it in the elected corner for extrication.

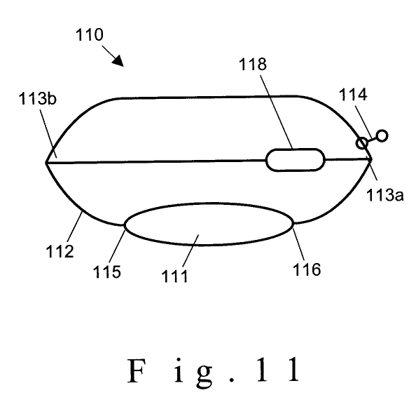

FIG. 11 shows an additional embodiment of a sinker 110, in which a float 118 is attached to its own filament, either slidably or fixedly. In the slidable configuration, the float slides along a filament preferably running from one corner to the other (in a two corner system) and preferably rigid to allow the float to slide therealong. Drawing elements 110-116 are analogous to 30-36. Although the float 118 may be fastened to the same filament 112 as the weight 111, it is preferable to use a separate filament, so that the float and weight may move past each other if required. Note that more than two filaments may be used, as well as multiple floats or weights. With a float of sufficient buoyancy, the float itself can help orient/urge/raise one end of the sinker system upwardly, to allow the line to more easily seek a corner or end when tensioned (i.e. pulled up). Otherwise, the fisherman may have to shake the line to find a corner.

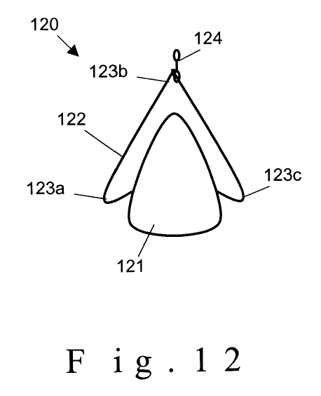

FIG. 12 shows an additional embodiment of a sinker 120, in which the weight 121 is not elongated, but is gumdrop or projectile shaped with an apex and a conical body. Note that although any shaped weight may be used, it may be preferable to use a shape in which the center of mass is located distant and perhaps as far from possible from the nominal clasp engagement corner 123b. Note that the corners 123a, 123b and 123c offer multiple engagement points for the slidable clasp 124, and do not necessarily have to be located on opposite sides of the weight 121. The filament is preferably rigid and extends outwardly from the weight and rises to an apex above the weight.

During nominal sinker operation (in other words, when the sinker is not snagged), it may be desirable for the sinker to hang from one particular corner. For instance, the sinker 120 of FIG. 12 may preferably hang from corner 123b during normal operation. One method to preferentially favor one corner over another is to tailor the filament shape so that when hung from one particularly undesirable corner, the clasp slides to the desired corner. Using the example of FIG. 12, if one accounts for the center of mass of weight 121, and properly locates corner 123a (or 123c) and the local slope at each point along the filament between 123a (or 123c) and 123b, the sinker will re-orient itself under the influence of gravity to the desired orientation. A guiding principle when designing the contour of the filament is that the local slope at each point (corner), when the entire sinker is hung from that point, should be large enough to overcome friction. When the filament is shaped properly, the clasp will preferably not get stuck between corners.

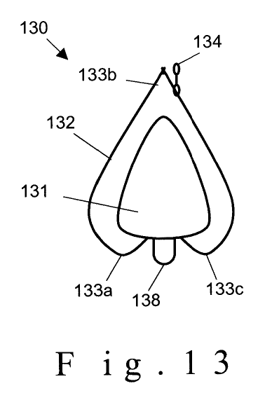

FIG. 13 shows another embodiment of a sinker 130, in which a rattle 138 is attached to the weight 131. Drawing elements 130-134 are analogous to 120-124.

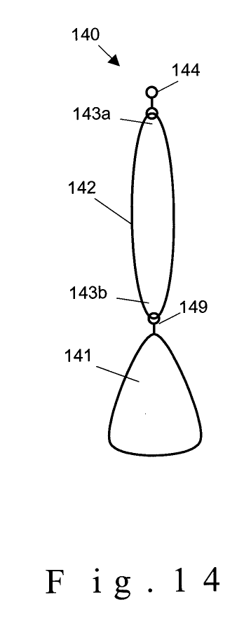

FIG. 14 shows another embodiment of a sinker 140, in which the weight 141 is attached to the filament 142 by a slidable clasp 149. Drawing elements 140-144 are analogous to 120-124. Note that the filament 142 is preferably rigid, and preferably retains its shape as the slidable clasps 144 and 149 move along it. Additional features may be combined with the embodiment in FIG. 14, including a float, a float on an additional filament, or a rattle.

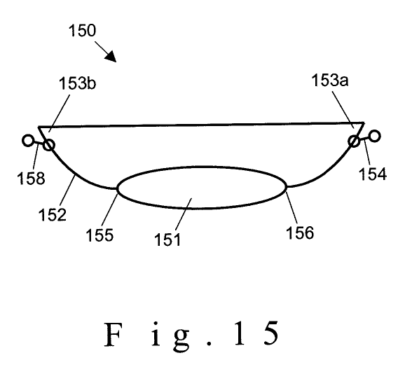

FIG. 15 shows another embodiment of a sinker 150, in which a second clasp 158 is slidably attached to the filament 152. Drawing elements 150-156 are analogous to 30-36. Slidable clasp 154 may be attached to the fishing line (connected to the fishing rod), and slidable clasp 158 may be attached to the bait (or to an intermediate line, which is in turn connected to the bait). During normal operation, clasp 154 is engaged with corner 153a, and clasp 158 is engaged with corner 153b. If the sinker 150 becomes snagged at the bottom of the fishing area, the slidable clasp 154 may be slid to corner 153b to dislodge the sinker 150, as shown in FIGS. 4 and 5. Note that more than two clasps may be used, as well.

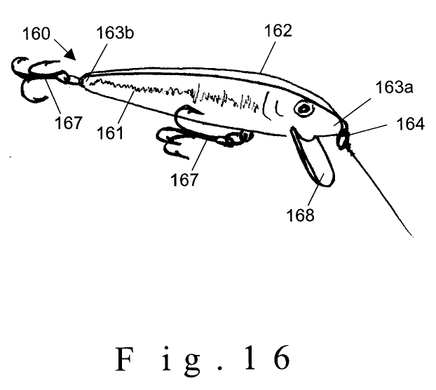

The weight on the sinker may also be shaped, colored and textured to be more appealing to fish. For instance, the sinker 160 of FIG. 16 has a weight 161 that resembles a fish. The exemplary filament 162 of FIG. 16 extends from the front end of the weight 161, at corner 163a, to the back end of the weight 161, at corner 163b, although it need not follow the contour of the weight, and need not span the full extent of the weight. The weight 161 shown in FIG. 16 is exemplary, and any decorative or functional design may be used, including geometric patterns. Furthermore, the weight may include hydrodynamic features, such as fins or ridges, that may cause the sinker to wiggle as it moves through the water, in order to lure fish. A lip 168 is shown on the sinker 160 in FIG. 16, which may impart a wiggling motion to the sinker as it passes through the water.

Note that the sinker 160 may have one or more additional features attached to it, including hooks 167. Note that the additional features, such as the hooks 167, may or may contribute to the sinking ability of the sinker, or the effectiveness in removing the sinker if it becomes stuck. Furthermore, the additional features may or may not directly contribute to the ability to lure or catch fish.

1. A snag resistant fishing sinker system, comprising
a. a first filament having a first and second end;
b. a sinker weight being attached to said first filament proximate said ends;
c. an attachment link to a fishing line, slidably engaging said first filament so that it can selectively slide between ends;
so that the link can be moved by tensioning of a fishing line to avoid entanglement of the system with environmental obstacles.

2. The system of claim 1 wherein said first filament is substantially rigid.

3. The system of claim 2 wherein said first and second ends are attached to said sinker weight to form at least one corner.

4. The system of claim 2 wherein said first and second ends are attached to said sinker weight to form at least two corners and wherein said link is slidable between said corners.

5. The system of claim 2 wherein said first filament includes a bend intermediate said first and second ends so that said link may engage said either said first or second end or said bend.

6. The system of claim 5 wherein said bend is generally midway between said first and second ends and forms an apex between said ends.

7. The system of claim 5 wherein said bend is generally midway between said first and second ends and wherein said filament follows a generally arcuate shape.

8. The system of claim 7 wherein said arcuate shape is concave relative to the sinker weight.

9. The system of claim 1 further including a further filament extending generally from said first to said second end and a float slidable therealong.

10. The system of claim 9 wherein said float has sufficient buoyancy to tend to raise whichever end it is most adjacent.

11. The system of claim 9 wherein said further filament is substantially rigid.

12. The system of claim 1 wherein said filament is substantially rigid and extends from the sinker weigh at one end thereof, follows around the sinker weight toward its other end and terminates at the sinker weight adjacent the first end and has a corner adjacent its second end, so that the link may be moved from the first end to the second to avoid environmental entanglement.

13. A snag resistant fishing device comprising
a. a first substantially rigid filament having a first and second end;
b. a second substantially rigid filament joining said first and second ends forming corners therewith;
c. a fishing element engaging said second filament;
d. an attachment link to a fishing line, slidably engaging said first filament so that it can selectively slide between ends;
so that the link can be moved by tensioning of a fishing line to avoid entanglement of the system with environmental obstacles.

14. The system of claim 13 wherein said element slidably engages said second filament

15. The system of claim 13 wherein said second filament follows an arcuate path and said first filament is generally linear.

16. A method of making a snag resistant sinker system comprising the steps of:
a. suspending a fishing element to the ends of a substantially rigid filament;
b. establishing a plurality of corner bends in said filament;
c. Slideably attaching a fishing line to said filament capable of sliding therealong and engaging said bends;
so that tensioning the fishing line at different angles can cause the slidable attachment to move to bend most effective in disentangling said sinker system from environmental obstacles.

17. The method of claim 16 wherein said establishing step includes establishing at least three corner bends and forming the filament in an arcuate path between at least some of the bends.

18. The method of claim 17 wherein said step of form includes forming the filament in an arcuate path being convex with respect to the fishing element.

19. The method of claim 16 wherein said fishing element is made to be slidable.
